(19) United States
(12) Patent Application Publication
(10) Pub. No.: US 2018/0303588 A1
(43) Pub. Date: Oct. 25, 2018

(54) ORAL CARE APPLIANCE AND ITS CARE HEAD

(71) Applicant: TTI (MACAO COMMERCIAL OFFSHORE) LIMITED, Macau (MO)

(72) Inventor: World Sai Kai HA, Dongguan City (CN)

(21) Appl. No.: 15/962,105

(22) Filed: Apr. 25, 2018

(30) Foreign Application Priority Data
Apr. 25, 2017 (CN) 201720438026.3

(51) Int. Cl. A61C 17/34; A46B 9/04; A61C 17/22

(52) U.S. Cl. CPC A61C 17/3472; A46B 9/04; A46B 2200/1066; A61C 17/222; A61C 17/3418

(57) ABSTRACT

A care head for an oral care appliance with a care head body and a care element. The care head body has a first portion adapted to connect with a handle of the oral care appliance, a second portion adapted to carry a care element on the front side of the care head body, and a flexible portion disposed between the first portion and the second portion. The care element is arranged at the second portion. The flexible portion is integrally formed with the first portion and the second portion. The flexible portion is formed by a compressible wall portion. The compressible wall portion defines a hollow space and has a through-hole and is compressible along the longitudinal direction of the care head body such that in use the second portion is reversibly bendable relative to the first portion. The invention also discloses an oral care appliance with the care head.

### CROSS-REFERENCE TO RELATED APPLICATIONS

This application claims foreign priority to Chinese Patent Application No. 201720438026.3 filed Apr. 25, 2017, the entire contents of which are hereby incorporated herewith.

### FIELD OF INVENTION

The invention relates to an oral care appliance, and more particularly, to a cleaning head for an oral care appliance.

### BACKGROUND OF THE INVENTION

Toothbrushes are well-known oral care appliances. A toothbrush typically includes a handle and a brush head attached to the handle. The brush head typically includes one or more bristle tufts for cleaning teeth and gums. By rapidly moving the brush head (manually or electrically), the bristle tufts may be caused to rotate and/or oscillate to clean the plaque and calculus formed on the teeth and gums.

In use, the user moves the toothbrush from one tooth to another, allowing the rotating or oscillating toothbrush (manual or electric) to do most of the cleaning work. As the alignment direction, configuration, and state of the teeth, as well as the force applied on the teeth by the user and the way by which the user brushes the teeth can all be different for different users, it is desirable to improve the operability and safety of the toothbrush.

### SUMMARY OF THE INVENTION

Embodiments of the invention provide a different or improved care head for an oral care appliance, such as but not limited to a brush head for a toothbrush.

According to the first aspect of the invention, there is provided a care head for an oral care appliance. The care head includes a care head body and a care element. The care head body has a first portion adapted to connect with a handle of an oral care appliance, a second portion adapted to carry a care element on the front side of the care head body, and a flexible portion (joint portion) disposed between the first portion and the second portion. The care element is arranged at the second portion. The flexible portion is integrally formed with the first portion and the second portion. The flexible portion is formed by a compressible wall portion that defines a hollow space, has a through-hole and can be compressed along the longitudinal direction of the care head body so that in use the second portion is reversibly bendable relative to the first portion. In one example, the flexible portion is integrally molded with the first portion and the second portion.

Optionally, in the default non-bent configuration, the length of the first portion (in the longitudinal direction of the care head body) is greater than the length of the second portion (in the longitudinal direction of the care head body). Optionally, in the default non-bent configuration, the length of the second portion (in the longitudinal direction of the care head body) is greater than the length of the flexible portion (in the longitudinal direction of the care head body). In one example, in the default non-bent configuration, the length of the first portion is about 48 millimeters, the length of the second portion is about 14 to 16 millimeters, and the length of the flexible portion is about 9 millimeters.

In a specific embodiment, the second portion is tiltable up to 10 degrees relative to the longitudinal axis of the care head body that is not bent. Preferably, the second portion is tiltable up to about 5 degrees relative to the longitudinal axis of the care head body that is not bent. More preferably, the second portion is tiltable up to about 4.5 degrees relative to the longitudinal axis of the care head body that is not bent.

In a specific embodiment, the direction of the reversible bending includes at least the front-rear direction of the care head. Preferably, the direction of the reversible bending is along any direction (360 degrees) of the care head.

Preferably, the care head body is made of a single polymeric material. Preferably, the polymeric material is polypropylene.

In a specific embodiment, the compressible wall portion includes a first rib and a second rib. The first rib is located on the back side of the care head and directly connected between the first portion and the second portion. The second rib is located on the front side of the care head and is directly connected between the first portion and the second portion.

In a specific embodiment, the first rib is substantially straight along the longitudinal axis of the care head body.

In a specific embodiment, the second rib includes a curved or angled portion that does not extend directly parallel to the longitudinal direction of the care head body (i.e., angled with respect to the longitudinal direction of the care head body), and is adapted to be deformed during the reversible bending. Optionally, the second rib includes a first substantially straight portion, a second substantially straight portion and a ring portion. The first substantially straight portion extends in a longitudinal direction of the care head body and is connected with the first portion. The second substantially straight portion extends in the longitudinal direction of the care head body and is connected with the second portion. The ring portion is connected between the first substantially straight portion and the second substantially straight portion. The ring portion can be in open or closed loop form. The ring portion can be oval, circular or polygonal.

Optionally, the compressible wall portion also includes at least one of the following: a third rib and a fourth rib. The third rib is located at a first side of the care head and the first side is located between the front side and the back side. The fourth rib is located at a second side of the care head, the second side being opposite the first side and located between the front side and the back side. Preferably, the third rib and the fourth rib have the same form.

In a specific embodiment, at least one of the second rib, the third rib, and the fourth rib includes a curved or angled portion (i.e., angled with respect to the longitudinal direction of the care head body), which does not extend directly parallel to the longitudinal direction of the care head body and is adapted to be deformed during the reversible bending.

Preferably, the first portion, the second portion and the flexible portion together define a chamber extending in the longitudinal direction of the care head body. Optionally, the second portion includes a lateral opening on the front side for mounting the care element, the lateral opening being communicated with the chamber.

In a preferred embodiment, the care element includes a bristle tuft carrying member. The bristle tuft carrying member includes a disk having a plurality of holes, and a plurality of bristle tufts mounted in a plurality of the holes and extending at least partially perpendicular to the disk.

In a specific embodiment, the care head further includes a shaft disposed in the chamber. The shaft is arranged to connect to the care element at one end and to the connector member at the other end. The connector member is adapted to be operably connected with a drive member in a handle of the oral care appliance such that in use the care element can be actuated by the drive member. Optionally, the connecting member is at least partially located in the chamber.

Preferably, the shaft can be reversibly bent so that in use the bending of the care head body can cause bending of the shaft.

In a preferred embodiment, the care head further includes a polymeric sleeve surrounding the flexible portion. Preferably, the polymeric sleeve is arranged to extend into the through-hole of the compressible wall portion. Preferably, the polymeric sleeve is overmolded on the flexible portion. In one embodiment, the polymeric sleeve is made of a thermoplastic elastomer.

In a specific embodiment, the oral care appliance is an electric toothbrush and the care element includes bristle tufts. In one example, the electric toothbrush is an oscillatory toothbrush with an oscillatory drive mechanism that, in use, drives the care element to oscillate (rotate to-and-fro) about an oscillation axis.

According to a second aspect of the invention, there is provided an oral care appliance, comprising a handle and a care head according to the first aspect of the invention connected to the handle. The oral care appliance is preferably a toothbrush, in particular an electric toothbrush.

According to a third aspect of the invention, there is provided an oral care appliance comprising: a handle of an oral care appliance; and one or more care heads according to the first aspect of the invention, which are adapted to be removably connected with the handle. The oral care appliance is preferably a toothbrush, in particular an electric toothbrush.

The care head for an oral care appliance of the invention has many advantages. For example, the care head for an oral care appliance of the invention has a simple structure, effectively providing improved operational flexibility of the care head without greatly increasing manufacturing cost and complexity. By integrally forming the flexible portion of the care head body with the first portion and the second portion, and forming the deformable compressible wall portion at the flexible portion, in combination with the flexibility or reversible bendability of the relatively stiff material itself, the care head can provide the user with a better oral care operation experience. In the example where the oral care appliance is a toothbrush, the flexibility or reversible bendability can prevent the user from discomfort or injury excessive force exerted on the toothbrush to press the toothbrush against the teeth or gum.

Other features and aspects of the invention will become apparent by considering the following detailed description and drawings.

### BRIEF DESCRIPTION OF THE DRAWINGS

Embodiments of the invention will now be described by way of examples with reference to the accompanying drawings, in which:

FIG. 1 is a perspective view of an oral care appliance according to one embodiment of the invention;

FIG. 2A is a perspective view of the care head of the oral care appliance of FIG. 1;

FIG. 2B is an exploded view showing the care head of FIG. 2A;

FIG. 2C is a cross-sectional view taken along dotted line A-A of FIG. 2A;

FIG. 3A is a front view of the care head body of the care head of FIG. 2A;

FIG. 3B is a left side view of the care head body of the care head of FIG. 2A;

FIG. 3C is a right side view of the care head body of the care head of FIG. 2A;

FIG. 3D is a rear view of the care head body of the care head of FIG. 2A;

FIG. 3E is a partial view of the care head body of the care head of FIG. 2A, showing the polymeric sleeve surrounding the flexible portion;

FIG. 4A is a schematic view showing the care head of FIG. 2A bent along the front-rear direction; and

FIG. 4B is a schematic view showing the care head of FIG. 2A bent along the left-right direction.

Before explaining any structure of the invention in detail, it is to be understood that the invention is not limited in its application to the structure of components and details of arrangement described in the following description or shown in the following drawings. The invention can include other structures and can be practiced or realized in various ways.

### DETAILED DESCRIPTION OF OF THE DRAWINGS

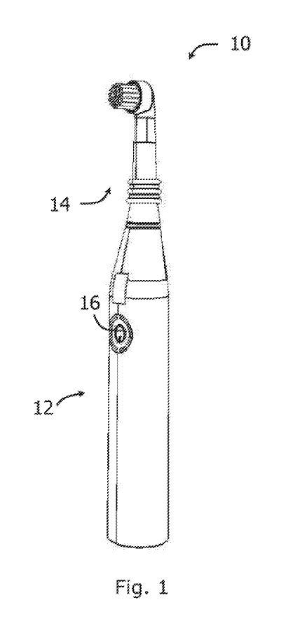

FIG. 1 shows an oral care appliance according to one embodiment of the invention. In the present embodiment, the oral care appliance is in the form of an electric toothbrush. The electric toothbrush 10 mainly includes a handle 12 and a brush head 14. Although not shown, in one example, a drive member for driving a cleaning element in the brush head 14, a control circuit for controlling operation of the drive member, and a power source are arranged in the handle 12. The drive member may include a motor and a transmission mechanism connected with the motor. The power source can be a rechargeable battery. The handle is provided with a button 16. The button 16 is connected to the control circuit in the handle 12 to allow the user to control on/off or mode of operation of the toothbrush 10. Optionally, an indicator light may be arranged on the handle 12 to indicate the amount of power, operation status, or charging status of the toothbrush 10. Although not shown, the upper part of the handle 12 is provided with a connection part adapted to be drivingly connected with the brush head 14. The connection part may include a male or female coupling portion that can be connected with a respective female or male coupling portion of the brush head 14 for transmitting the drive of the drive member to the cleaning element of the brush head through the drive mechanism connected with the drive member so as to drive operation of the cleaning element. It should be understood that the electric toothbrush 10 may have different structures and may have additional or less functional or structural features.

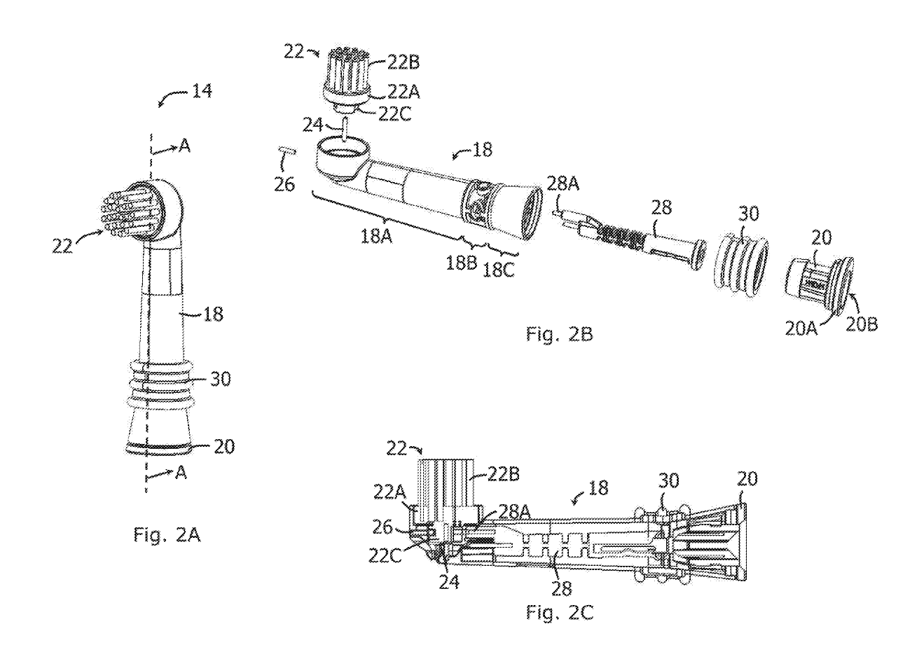

FIGS. 2A to 2C illustrate the brush head 14 of the electric toothbrush 10 of FIG. 1. As shown in FIGS. 2A to 2C, the brush head 14 includes a body 18. The body 18 has a first portion 18C adapted to be connected with the handle 12 through a connector member 20, a flexible portion (joint portion) 18B, and a second portion 18A adapted to carry the cleaning element 22 on the front side. In one example, the length of the first portion 18C is greater than the length of the second portion 18A, and the length of the second portion 18A is greater than the length of the flexible portion 18B. In other examples, the length of the first portion 18C may be equal to or less than the length of the second portion 18A. The flexible portion 18B is located between the first portion 18C and the second portion 18A and is integrally formed with the first portion 18C and the second portion 18A. The flexible portion 18B is formed by a compressible wall portion. The compressible wall portion defines a hollow space that extends along the longitudinal direction of the brush head 14. The compressible wall portion also includes a through-hole and is compressible along the longitudinal direction of the body 18. Specifically, when subjected to a force, the compressible wall portion may be rotated or pivoted with respect to the longitudinal direction of the body 18 (longitudinal direction in a default, non-bent configuration) so as to compress the compressible wall portion in the longitudinal direction of the body 18. A reliable spring-back can be achieved by the structure of the compressible wall portion and the stiffness of the material of the compressible wall portion. With such design, in use, the second portion 18A can reversibly bend with respect to the first portion 18C. Preferably, the flexible portion 18B is integrally molded with the first portion 18C and the second portion 18A. In the present embodiment, the brush head 14 is made of a single polymeric material. Preferably, the polymeric material is plastic, such as polypropylene. Referring to FIGS. 2A and 2B, the first portion 18C, the second portion 18A, and the flexible portion 18B together define a chamber extending along the longitudinal direction of the body 18. The hollow space defined by the compressible wall portion of the flexible portion 18B may be part of the chamber. A lateral opening for mounting the cleaning element 22 is arranged on the front side of the second portion 18A. Preferably, the chamber communicates with the lateral opening.

The brush head 14 also includes a cleaning element 22 mounted in the lateral opening of the second portion 18A by latching pins 24, 26. In the present embodiment, the cleaning element 22 is a bristle tuft carrying member. This member includes a disk 22A on which holes are arranged, and bristle tuft(s) 22B are respectively mounted in the corresponding holes. Preferably, bristle tufts 22B extend at least partially perpendicular to disk 22A. The lower portion of the disk 22A has a stepped portion 22C. The stepped portion 22C includes a hole substantially perpendicular to the longitudinal direction of brush head 14 for receiving latching pin 24, a hole substantially parallel to the longitudinal direction of the brush head 14 for receiving latching pin 26, and an opening substantially parallel to the longitudinal direction of the brush head 14 for connecting with a shaft 28 arranged in the chamber. In one example, the stepped portion 22C may be driven by the shaft 28 to drive the cleaning element 22 to swing and oscillate (rotate to-and-fro) about the axis defined by the latching pin 24.

As described above, the brush head 14 also includes a shaft 28 disposed in the chamber. As shown in FIG. 2C, a pin 28A at one end of the shaft 28 is connected to the opening in the stepped portion 22C of the cleaning element 22, and the other end of the shaft 28 is connected to the connector member 20. Preferably, the shaft 28 is also reversibly-bendable such that in use the shaft 28 may bend as the body 18 of brush head 14 bends. This does not only reduce the bending stress acting on the shaft 28, but can also utilize the stiffness and reversibly-bendable property of the shaft 28 to restore of the body 18 from the bent position. The connector member 20 is adapted to be connected with a connection part of the handle 12 and hence operably connected with the drive member in the handle 12, so that in use the cleaning element 22 can be driven by the drive member. As shown in FIG. 2C, the connector member 20 is at least partially located in the chamber. In the present embodiment, the body of the connector member 20 has a flange 20A and defines a female coupling portion 20B. The female coupling portion 20B is adapted to engage with a corresponding male coupling portion of the connection part of the handle 12. The flange 20A abuts an axial end of the first portion 18C. In one example, the connector member 20 may be integrated with the body 18.

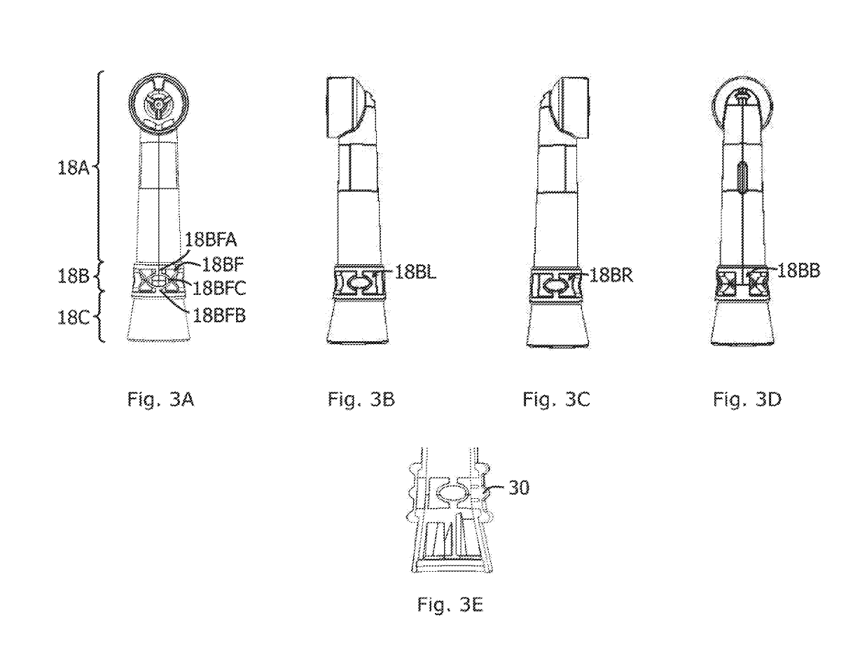

The brush head 14 of the present embodiment also includes a sleeve 30 that wraps around the flexible portion 18B. Preferably, the sleeve 30 is made of a polymer. In one embodiment, the sleeve 30 is made of a thermoplastic elastomer. As shown in FIG. 3E, the sleeve 30 may be arranged to extend into the through-hole of the compressible wall portion of the flexible portion 18B. Preferably, the sleeve 30 is overmolded onto the flexible portion 18B.

FIGS. 3A to 3D show the structure of the body 18 of the brush head 14. As described above, the body 18 is generally formed by the first portion 18C, the second portion 18A, and the flexible portion 18B. A preferred embodiment of the compressible wall portion of the flexible portion 18B is shown in FIGS. 3A to 3D. In the present embodiment, the compressible wall portion includes a first rib 18BB (FIG. 3D) on the back side of the brush head 14 and directly connected between the first portion 18C and the second portion 18A. The first rib 18BB may be substantially straight along the longitudinal direction of the body 18. The compressible wall portion also includes a second rib 18BF (FIG. 3A) located on the front side of the brush head 14 and directly connected between the first portion 18C and the second portion 18A. Preferably, the second rib 18BF includes a curved or angled portion that is adapted to be deformed during reversible bending of the brush head 14. This portion does not extend directly parallel to the longitudinal direction of the body 18, but is angled with respect to the longitudinal direction of the body 18 to provide a non-longitudinal force component so as to provide a reliable reversible bending effect.

In the example of FIG. 3A, the second rib 18BF includes a first substantially straight portion 18BFA, a second substantially straight portion 18BFB, and a ring portion 18BFC. The first substantially straight portion 18BFA extends in the longitudinal direction of the body 18 and is connected with the first portion 18C. The second substantially straight portion 18BFB extends in the longitudinal direction of the body 18 and is connected with the second portion 18A. The ring portion 18BFC is connected between the first substantially straight portion 18BFA and the second substantially straight portion 18BFB. The ring portion 18BFC can be in open or closed loop form. Optionally, the ring portion 18BFC may be oval, circular, or polygonal. It should be understood that the second rib 18BF may have no ring portion 18BFC and have other structures capable of providing a non-longitudinal force component.

Optionally, the compressible wall portion further includes a third rib 18BL (FIG. 3B) on the left side of the brush head 14 and directly connected between the first portion 18C and the second portion 18A; and a fourth rib 18BR (FIG. 3C) on the right side of the brush head 14 and directly connected between the first portion 18C and the second portion 18A. In one embodiment, the structures of the third rib 18BL and the fourth rib 18BR are similar to the structure of the second rib 18BF. Preferably, the third rib 18BL and the fourth rib 18BR have the same structure to provide better balance. It should be understood that the third rib 18BL and the fourth rib 18BR may have any structures capable of providing non-longitudinal force component. In the present embodiment, through-holes are defined in respective spaces between the first rib 18BB, the second rib 18BF, the third rib 18BL, and the fourth rib 18BR, and a hollow space extending along the longitudinal direction of the body 18 is defined therebetween.

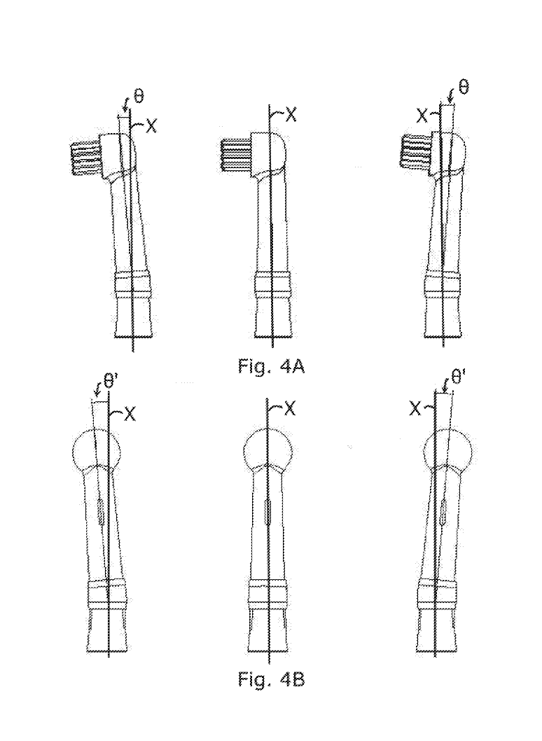

FIGS. 4A and 4B illustrate the bending of the brush head 14 of FIG. 2A. As shown in FIG. 4A, the second portion 18A can be bent by a certain angle θ along the front-rear direction of the body 18 with respect to the longitudinal axis X of the body 18 that is not bent. This angle θ can be up to 10 degrees and preferably up to about 5 degrees. In the present embodiment, the angle is at most about 4.5 degrees. FIG. 4B shows that the second portion 18A can be inclined by a certain angle θ′ along the left-right direction of the body 18 with respect to the longitudinal axis X of the body 18 that is not bent. This angle θ′ can be up to 10 degrees and preferably up to about 5 degrees. In this embodiment, the angle is at most about 4.5 degrees. In a preferred embodiment, the direction of the reversible-bending can be along any direction (360 degrees) of the body 18.

The above describes a preferred embodiment of the care head for an oral care appliance of the invention, which is a brush head for an electric toothbrush. It should be understood that the care head for an oral care appliance of the invention may be the head of any toothbrush and is preferably a replaceable brush head for an oscillating electric toothbrush. Of course, in some examples, the toothbrush is not electric but is manual. Also, the care head may be not replaceable or not detachable. In some examples, the oral care appliance may not be a toothbrush, but is a gum massager or any other oral care appliance, in which the care head includes a corresponding care element (such as a massage element or other cleaning element). It should be understood that the oral care appliance of the invention that utilizes the care head may have different structures and have additional or less functional or structural features. In addition, the care head of the invention may also have different structures and have increased or decreased functional or structural features. For example, the first portion 18C and the second portion 18A of the care head body 18 may not be hollow. The orientation of the care element can be different. Those skilled in the art will recognize that many variations and/or modifications may be made to the invention as described in the specific embodiments without departing from the spirit or scope of the invention as broadly described. The present embodiments should therefore be considered in all respects as illustrative not restrictive.

1. A care head for an oral care appliance, comprising:
a care head body, including
a first portion adapted for connection with a handle of the oral care appliance;
a second portion adapted to carry a care element on a front side of the care head body; and
a flexible portion arranged between the first portion and the second portion; and
a care element, arranged at the second portion;
wherein the flexible portion is integrally formed with the first portion and the second portion; and
wherein the flexible portion is formed by a compressible wall portion; the compressible wall portion defines a hollow space and has a through-hole and is compressible along the longitudinal direction of the care head body so that in use the second portion can be reversibly bent relative to the first portion.

2. The care head according to claim 1, wherein the second portion is tiltable up to 5 degrees with respect to the longitudinal axis of the care head body that is not bent.

3. The care head according to claim 1, wherein the direction of the reversible bending includes at least a front-rear direction of the care head.

4. The care head according to claim 1, wherein the care head body is made of a single polymeric material.

5. The care head according to claim 1, wherein the compressible wall portion includes:
a first rib located at the back side of the care head and directly connected between the first portion and the second portion; and
a second rib located on the front side of the care head and is directly connected between the first portion and the second portion.

6. The care head according to claim 5, wherein the first rib is substantially straight along a longitudinal direction of the care head body.

7. The care head according to claim 5, wherein the second rib includes a curved or angled portion that does not extend directly parallel to the longitudinal direction of the care head body and is adapted to be deformed during the reversible bending.

8. The care head according to claim 5, wherein the second rib includes:
a first substantially straight portion that extends in a longitudinal direction of the care head body and connects with the first portion;
a second substantially straight portion that extends in the longitudinal direction of the care head body and connects with the second portion; and
a ring portion connected between the first substantially straight portion and the second substantially straight portion.

9. The care head according to claim 5, wherein the compressible wall portion further comprises at least one of the following:
a third rib at a first side of the care head, the first side being located between the front side and the back side; and
a fourth rib at a second side of the care head, the second side being opposite the first side and located between the front side and the back side.

10. The care head according to claim 9, wherein at least one of the second rib, the third rib, and the fourth rib includes a curved or angled portion that does not extend directly parallel to the longitudinal direction of the care head body and is adapted to be deformed during the reversible bending.

11. The care head according to claim 1, wherein the first portion, the second portion, and the flexible portion together define a chamber extending in a longitudinal direction of the care head body.

12. The care head according to claim 11, wherein the second portion includes a lateral opening on the front side for mounting the care element, the lateral opening is in communication with the chamber.

13. The care head according to claim 12, wherein the care element comprises a bristle tuft carrying member, the bristle tuft carrying member comprising:
a disk having a plurality of holes, and
a plurality of bristle tufts mounted in the plurality of holes and extending at least partially perpendicular to the disc.

14. The care head according to claim 12, further comprising a shaft disposed in the chamber, the shaft being arranged to be connected to the care element at one end and to the connector member at the other end; the connector member is adapted to be operably connected with a drive member in a handle of the oral care appliance such that in use the care element can be driven by the drive member.

15. The care head according to claim 14, wherein the shaft is reversibly bendable such that in use the bending of the care head body can cause bending of the shaft.

16. The care head according to claim 1, further comprising a polymeric sleeve surrounding the flexible portion.

17. The care head according to claim 16, wherein the polymeric sleeve is arranged to extend into the through-hole of the compressible wall portion.

18. The care head according to claim 1, wherein the oral care appliance is an electric toothbrush and the care element includes bristle tufts.

19. The care head according to claim 18, wherein the electric toothbrush is a oscillatory toothbrush with an oscillatory drive mechanism that, in use, drives the care element to oscillate about an oscillation axis.

20. An oral care appliance comprising a handle and a care head according to claim 1 and connected or connectable to the handle.

21. The oral care appliance according to claim 20, wherein the oral care appliance is an electric toothbrush.

22. An oral care kit, comprising:
a handle of an oral care appliance; and
one or more care heads according to claim 1, adapted to be removably connected with the handle.

23. An oral care kit according to claim 22, wherein the oral care appliance is an electric toothbrush.
